(19) United States
(12) Patent Application Publication
(10) Pub. No.: US 2007/0174339 A1
(43) Pub. Date: Jul. 26, 2007

(54) System and method for determining personal genealogical relationships and geographical origins including a relative confidence

(76) Inventor: Brian A. Kolo, Centreville, VA (US)

Correspondence Address: Brian A. Kolo;Suite 350, 8260 Greensboro Dr., McLean, VA, 22102, US

(21) Appl. No.: 11/516,580

(22) Filed: Sep. 7, 2006

Related U.S. Application Data
(60) Provisional application No. 60/714,368, filed on Sep. 7, 2005.

(51) Int. Cl. G06F 17/00

(52) U.S. Cl. 707/104.1

(57) ABSTRACT

The present invention is directed toward identifying potential genealogical relationships between a plurality of individuals through name analysis and assigning to each identified relationship a value related to the confidence that the identified relationship exists.

### BACKGROUND OF THE INVENTION

In some cultures an individuals name is deeply connected with genealogical history. In these cultures it is common for parents to give a child only a single name. We will refer to this as the child's given name. The child may have several other names, but these names are predetermined by the child's genealogy.

For instance, in the Arab culture, it is common for parents to provide a child with a single given name. The child will have other names derived from the child's paternal genealogy. In this case, the child's second name is the same as the child's father's given name. The child's third name is the same as the child's paternal grandfather's given name. The child may have a fourth name which is the child's paternal grandfather's father's given name. This may continue as far back as the child is able to determine it's paternal genealogy.

As another example, many Hispanic persons are named using maternal genealogy. This naming convention is similar to that of the Arab culture discussed above. The main difference is instead of tracing paternal genealogy, this naming convention uses maternal genealogy. Other cultures, such as Russian, incorporate genealogy into names in similar ways.

### BRIEF SUMMARY OF THE INVENTION

The present invention is directed toward the detection of genealogical relations among individuals based upon the names of the individuals under study.

The present invention is also directed to software used to automate a genealogical study of individuals using names as part of the input to the software.

The present invention is also directed to the detection of terrorists and relatives of terrorists using genealogical information found in the terrorist's name.

The present invention is also directed to the prevention of terrorism by locating and identifying terrorists.

The present invention is also directed to the determining the city of origin or clan of people of interest.

The present invention is also directed toward determining parent-child relationships provided only the name of a parent.

### BRIEF DESCRIPTION OF THE DRAWINGS

FIG. 1a shows an example of an Arabic name and specifically identifies each sub-name of the name.

FIG. 1b shows an example of an Arabic name equivalent to the name in FIG. 1a.

FIG. 1c shows an example of an Arabic name equivalent to the name in FIG. 1a.

FIG. 1d shows an example of an Arabic name equivalent to the name in FIG. 1a.

FIG. 1e shows an example of an Arabic name equivalent to the name in FIG. 1a.

FIG. 1f shows an example of an Arabic name equivalent to the name in FIG. 1a.

FIG. 1g shows an example of an Arabic name equivalent to the name in FIG. 1a.

FIG. 2a shows an example of an Arabic name including a kunya indicating a first born son.

FIG. 2b shows an example of an Arabic name equivalent to the name in FIG. 2a.

FIG. 2c shows an example of an Arabic name equivalent to the name in FIG. 2a.

FIG. 2d shows an example of an Arabic name equivalent to the name in FIG. 2a.

FIG. 2e shows an example of an Arabic name equivalent to the name in FIG. 2a.

FIG. 3 first shows an Arabic name and follows with several names with genealogical connections to the first name, specifically showing names of a brother.

FIG. 4 first shows an Arabic name and follows with several names with genealogical connections to the first name, specifically showing names of a paternal first cousin.

FIG. 5a provides an example of a man's name and a genealogical interpretation of the name including clan and city of origin.

FIG. 5b provides an example of a woman's name and a genealogical interpretation of the name including clan and city of origin.

The Individual's name is broken into 7 parts, specifically Um Aban Afia bint Ali Al-Masry Al-Tikrit, which means Afia daughter of Ali, mother of Aban, of the clan Masry, from the city of Tikrit (506).

FIG. 6 shows a method of identifying relationships between two people.

FIG. 7 details the process of determining a genealogical relationship between two people.

FIG. 8 details the process of determining a genealogical relationship between two people.

FIG. 9a shows the matching of sub-names between a Test and Example name.

FIG. 9b shows the matching of sub-names between a Test and Example name.

FIG. 9c shows the matching of sub-names between a Test and Example name.

FIG. 9d shows the matching of sub-names between a Test and Exmpla name.

FIG. 10 shows how test names are provided from Batch Processing.

FIG. 11a shows the process for calculation or computing the score using an unordered test.

FIG. 11b shows the process for calculation or computing the score using an ordered test.

FIG. 12 shows a table of the numbers of ordered cycles appearing in a list.

### DETAILED DESCRIPTION OF THE INVENTION

Arabs often use a naming convention that incorporates paternal genealogy. A parent chooses only one name for a child. This is the child's given name. The rest of the child's name is predetermined by the genealogy of the father. The child's second name will the father's given name. The child's third name will the given name of the father's father.

The fourth name will be the father's father's father's given name. This process is carried out as far as the paternal genealogy is known. Thus, a child may have twenty or more names added to the given name.

In addiction, a clan, sub-tribe, region, city, and/or country name may be added. These names appear at the end of the genealogy names. These names commonly start with ‘el-’ or ‘al-’ indicating the name following is a clan or city.

Since an individual may have twenty or more names, it is common for an individual to choose a subset of these names to refer to themselves. Commonly an individual will use their given name and some of their genealogical names and will maintain their genealogical order. However, it is also common for a person to choose to skip generations in their name. This is often the case when a particular person in the genealogy earned great respect. For instance, if a person named Osama had a grandfather who befriended a king, he may choose to be known as Osama Laden rather than Osama Mohamed Laden.

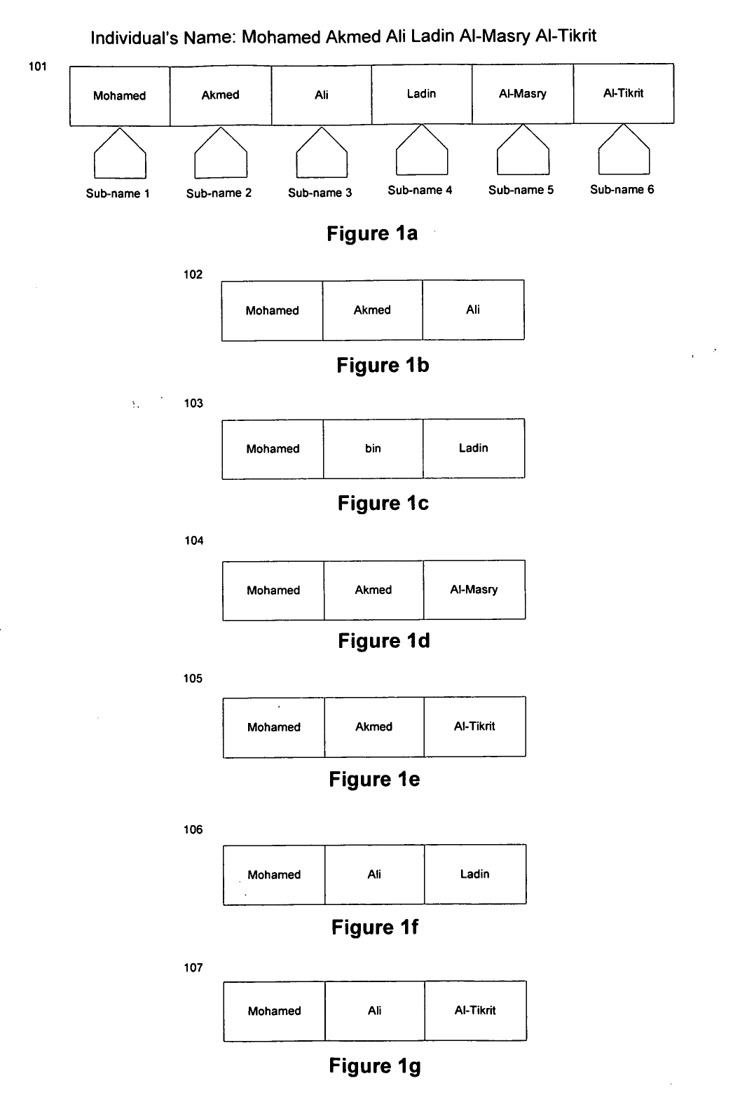

FIG. 1a provides an example of an Arabic name. An individuals name may have several parts. Each part is also a name, and theses individual parts will be referred to a sub-names. The sub-names for the name Mohamed Ahmed Ali Ladin Al-Masry Al-Tikrit is shown in FIG. 1a. The sub-names are all separated by a space, and in this case are Mohamed, Ahmed, Ali, Ladin, Al-Masry, and Al-Tikrit.

One interesting aspect of the Arabic naming convention is an individual may refer to themselves by using any of a large combination of sub-names. FIG. 1b provides an example of a name that might be used by the person in FIG. 1a. In this case, this person has chosen to use the first three names. This person may do so as long as they maintain the order of the names.

In addition, as shown in FIG. 1c, the Arabic naming convention allows addition of some terms into a name. In this case, the term ‘bin’ is added between Mohamed and Ladin.

The term ‘bin’ indicates that Mohamed descends from a individual named Ladin. Although this is often used to indicate that Mohamed is the son of Ladin, a father-son relationship is not necessary. Ladin may be Mohamed's father, grandfather, great-grandfather, etc.

However, ‘bin’ is not the only term that can be inserted. ‘bin’, ‘ibn’, ‘ould’, and ‘bint’ all indicate a type of relationship. ‘bin’, ‘ibn’, and ‘ould’ are used to indicate a father-son relationship, while ‘bint’ indicates a father-daughter relationship. Thus, a name such as Mohameda bint Laden indicates Mohameda is a female descendant of Ladin. Again, Ladin may be Mohameda's father, grandfather, great-grandfather, etc.

FIG. 1d provides another example of a name that might be used by the individual named in FIG. 1a. In this example the individual has adopted the name Mohamed Ahmed Al-Massy. Another equivalent name would be Mohamed bin Ahmed Al-Massy. These two names are effectively the same and are both available to the individual names in FIG. 1a.

FIG. 1e provides another example of a name that might be used by the individual named in FIG. 1a. In this case the person has adopted a given name, his fathers given name, and the city name Al-Tikrit. This city name indicates this person is from the city of Tikrit.

FIG. 1f shows an example of skipping generations. This person uses his given name and the names of his grandfather and great-grandfather. Again, which names a person chooses to use is entirely at his or her discretion. Typically a person will use his given names and some genealogical name.

FIG. 1g provides a final example of a name the individual of FIG. 1a may choose to use. This individual uses his given name, his grandfather's name, and his city name.

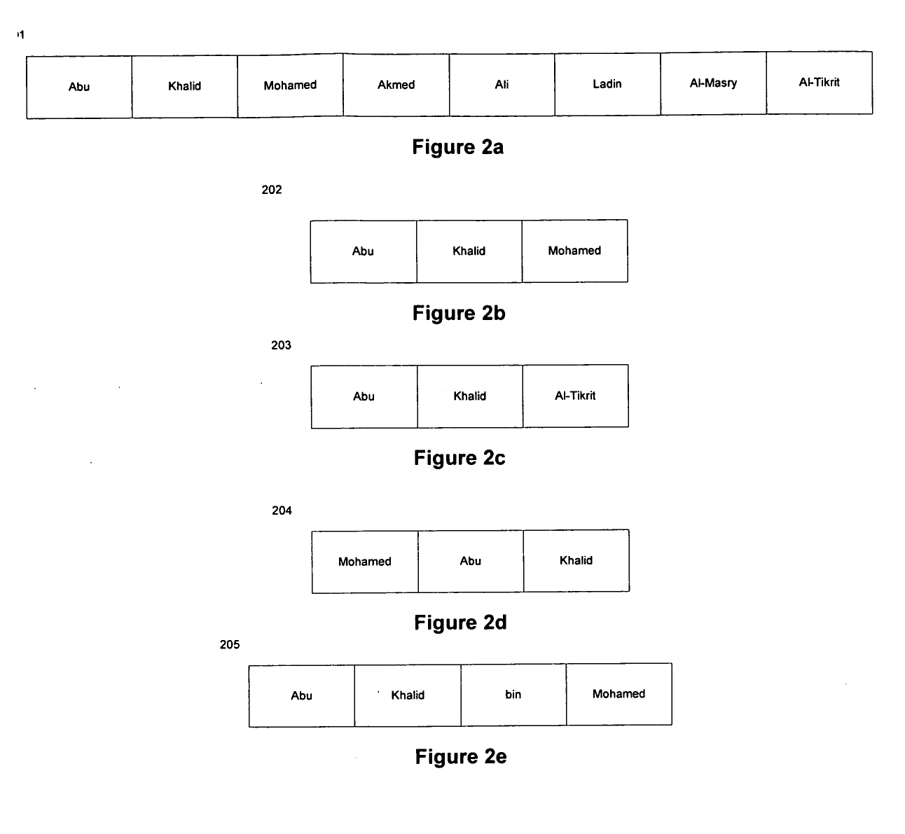

When a person has a first born son or daughter, they may adopt a kunya to their name. The kunya expresses they are a parent and adds the name of their child to the parent's name. As an example, if the individual from FIG. 1a were to have a son named Khalid, they may add Abu Khalid to the beginning of their name. Their new name is shown in FIG. 2a.

FIGS. 2b-e shows various names this person may now use including the kunya. Particular attention is drawn to the name shown in FIG. 2d. Here the kunya appears after the person's given name.

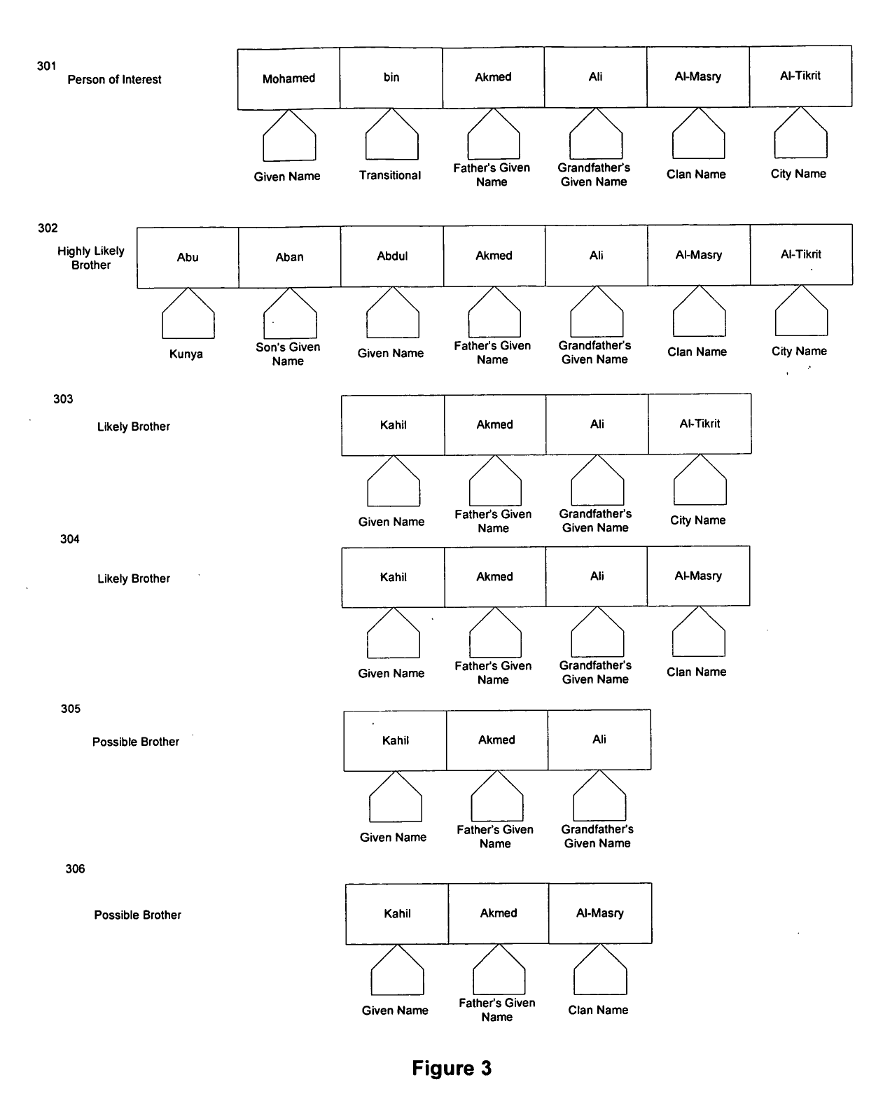

FIG. 3 begins with an individual's name explicitly showing the given name, names of the father and grandfather, a transitional, and a clan and city name. Since a person's name carries genealogical information, this person's brother would have a very similar name. The remainder of FIG. 3 provides some possible names for a brother.

In the first example, an individual named Abu Aban Adbul Ahmed Ali Al-Masry Al-Tikrit could be a name of a brother. This can be seen by comparing these two names. First, note the city name is the same, indicating these two people are form the came city. Furthermore, the both share the clan name Al-Masry. Additionally, both have the same father (Ahmed) and grandfather (Ali). With this information, it is highly likely these two people are brothers.

In the second example in FIG. 3, a person named Kahil Ahmed Ali Al-Tikrit is likely a brother to the person of interest. In this case it is seen that they both originate from the same city (Tikrit) and both have father's with the same name (Ahmed) and grandfather's with the same name (Ali). Thus, it is likely these two individuals are brothers.

Another example of a likely brother is an individual names Kahil Ahmed Ali Al-Masry. Again, these two share the same father and grandfather name. In addition, they share the same clan name (Al-Masry).

The fourth example shows a possible brother with the name Kahil Ahmed Ali. Again, these two share the same father and grandfather name. However, since there we don't have any information about the clan or city name, we cannot be as certain as in the previous cases.

As a final example shows another possible brother named Kahil Ahmed Al-Masry. In this case we see they share a clan name (Al-Masry) and a father's name (Ahmed). This indicates a potential sibling relationship, but the likelihood is not as strong as the earlier cases.

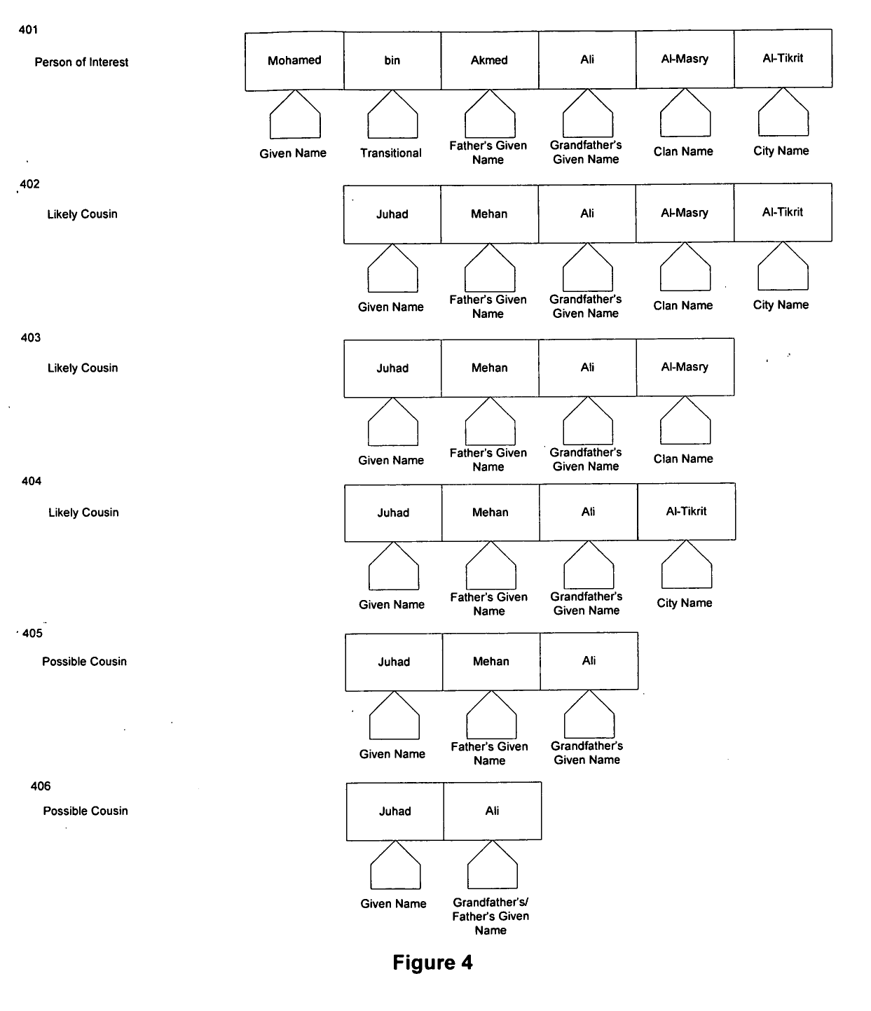

FIG. 4 provides a name of a person of interest and shows some potential names of first cousins. Again, because of the Arabic naming convention, this relationship can be discovered if these people have the same grandfather. This process is similar to that detained in FIG. 3, except rather than matching father, grandfather, clan, and city, we only match grandfather, clan, and city.

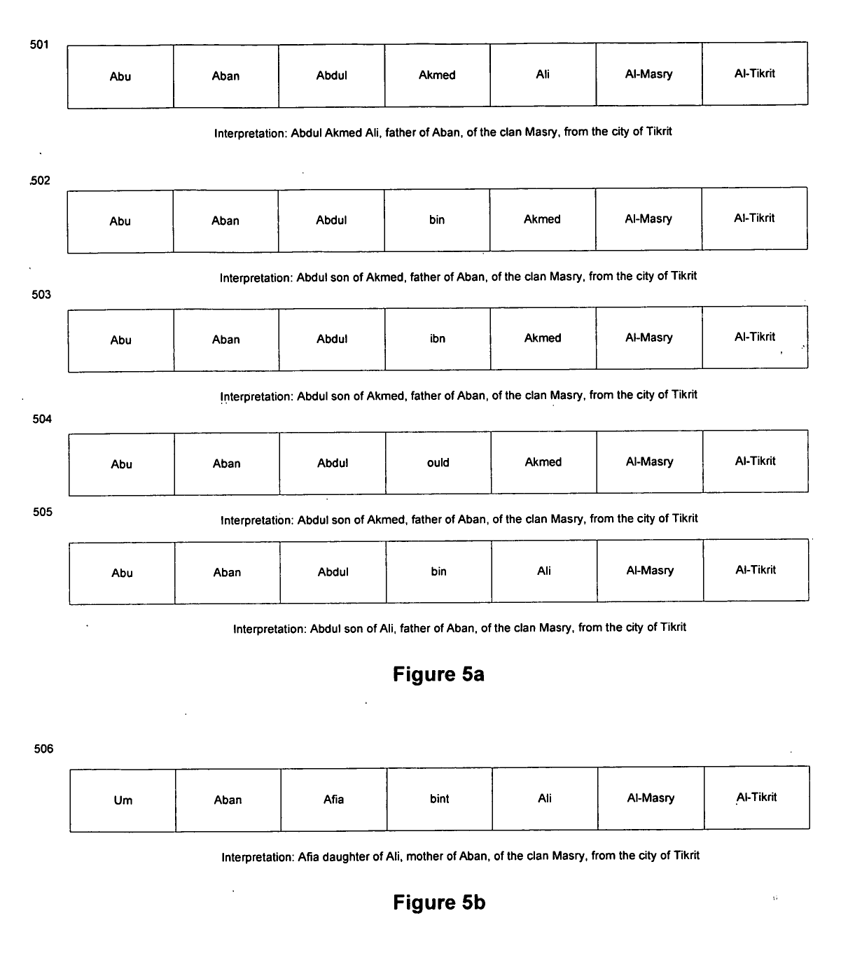

FIG. 5a shows some possible Arabic names along with an English interpretation. The first name, Abu Aban Abdul Ahmed Ali Al-Masry Al-Tikrit can be interpreted as Abdul Ahmed Ali, father of Aban, of the clan Masry, from the city of Tikrit.

The second name, Abu Aban Abdul bin Ahmed Al-Masry Al-Tikrit can be interperted as Abdul son of Ahmed, father of Aban, of the clan Masry, from the city of Tikrit. This name introduces the transitional ‘bin’. The third and fourth names have the same interpretation, only they use different transitionals. The third name uses the transitional ‘ibn’ while the fourth name uses ‘ould’. Both transitionals have the same meaning as the transitional ‘bin’.

The final example in FIG. 5a shows use of a name skipping a generation. The name Abu Aban Adbul bin Ali Al-Masry Al-Tikrit can be interperted as Abdul, son of Ali, father of Aban, of the clan Masry, from the city Tikrit. Again, the terms ‘bin’, ‘ibn’, and ‘ould’ are interpreted as ‘son of’. However, this does not necessarily indicate a direct father-son relationship. This could be grandfather-grandson, great-grandfather-great-grandson, etc.

FIG. 5b is similar to FIG. 5a, except in this case a woman's name is used. The name Um Aban Afia bint Ali Al-Masry Al-Tikrit can be interpreted as Afia, daughter of (bint) Ali, mother of (Um) Aban, of the clan Masry, from the city of Tikrit.

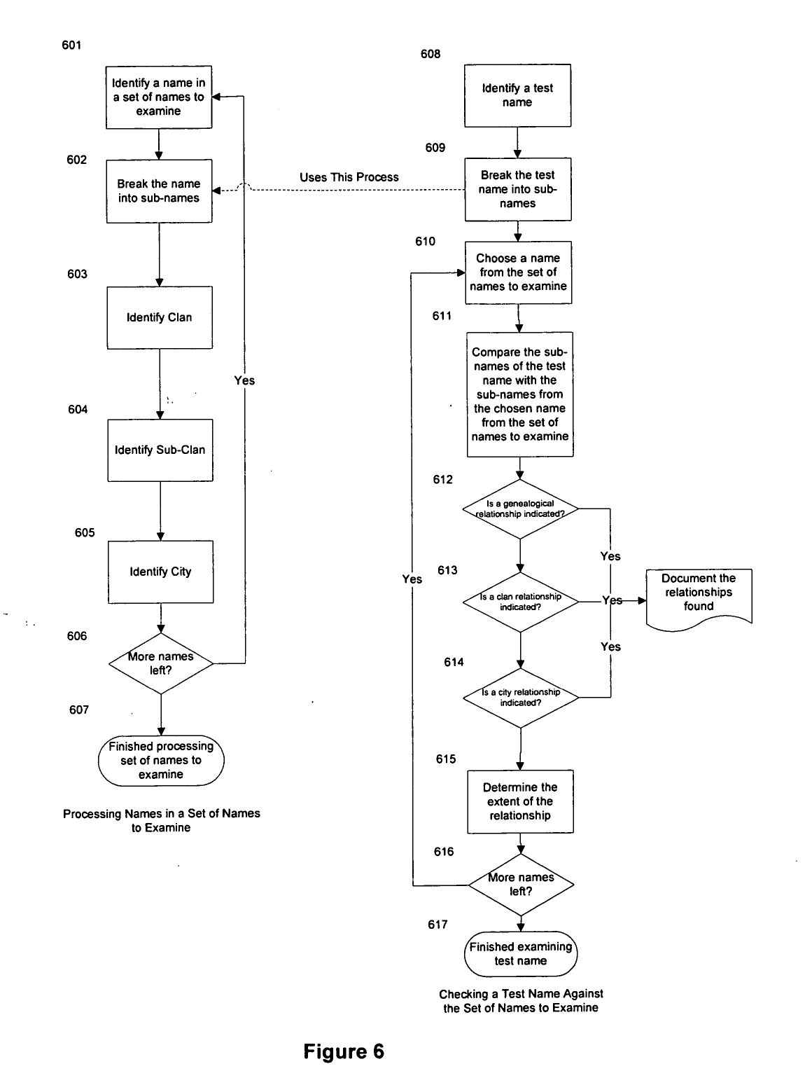

FIG. 6 is a flowchart for a method of identifying relationships between a set of people. First, a set of names is provided representing example names to check. Each of these names is broken into sub-names and a record of the names and sub-names is created. Next, a test name is provided. This test name is also broken into sub-names. The sub-names in the test name is compared to each example name. When performing this check, a genealogical comparison is made. In addition, the clan, sub-clan, and city names are compared. If any of these comparisons indicate a match, a record is made tracking the type of match found. The results are compiled and an additional step is performed which examines the extent of the relationship found. These comparisons are detailed below.

Genealogical Relationship

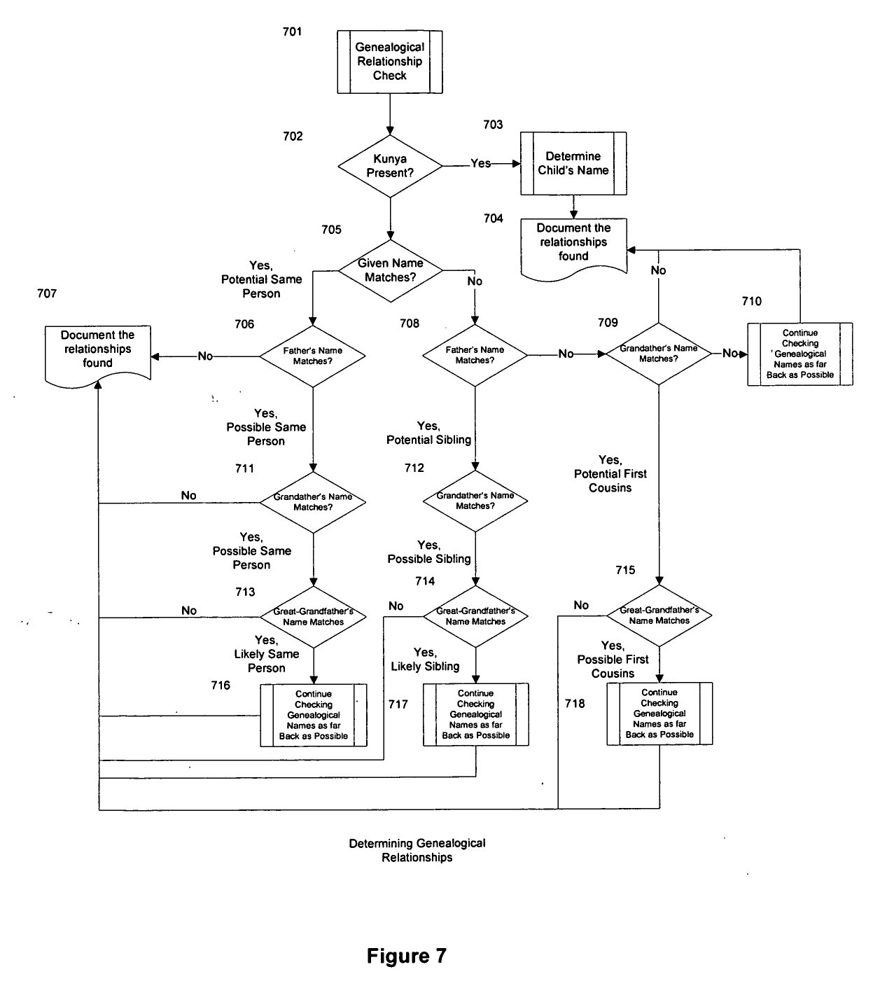

Comparing genealogies is a multiple step process and is diagrammed in FIG. 7. First the kunya is located. If a kunya such as ‘Abu’ or ‘Um’ is present, if indicates a parent-child relationship. The name following the kunya is identified as a child of the person named. From the parent name and the kunya, the child's name can be determined. If the named person is male, the child's name is the name after the kunya, followed by the parents name. If a kunya is found the child's name may be recorded for further study.

Next the first given name of the test name and the first given name of the example name is compared. If these names are the same, it is possible these two names refer to the same individual.

If the first given names are the same, the father's name is compared. If these names are also the same, this is further evidence the names refer to the same individual. Each successive name is then compared. A notation is made indicating how many successive names match. If at some point one of these genealogical names differ, the names may still refer to the same individual. In this case the individual may have used two different versions of their names. Again, a notation should be made indicating this possibility. Additionally, this may indicate the two names refer to related individuals.

If the first given names do not match, the second names are compared. If these are the same, a sibling relationship is possible. In this case the third name is checked. If these are also the same, this strengthens the chances the two names refer to siblings. Further names are then checked. The more names in common, the more likely these names refer to siblings, and a notation is made indicating the extent of the names matching. If at some point a name does not match, the names may still refer to siblings. Again, a notation is made indicating the extent of the names found to match.

If the given name and father's name do no match, the grandfather's name should be checked. If these match, the named individuals may be first cousins. Just as in the previous cases, further study of successive matching names strengthens the likelihood of a first cousin relationship.

This process continues checking successive names. If the sub-names of the two names match at some point, a potential relationship is indicated. Any potential relationship is noted.

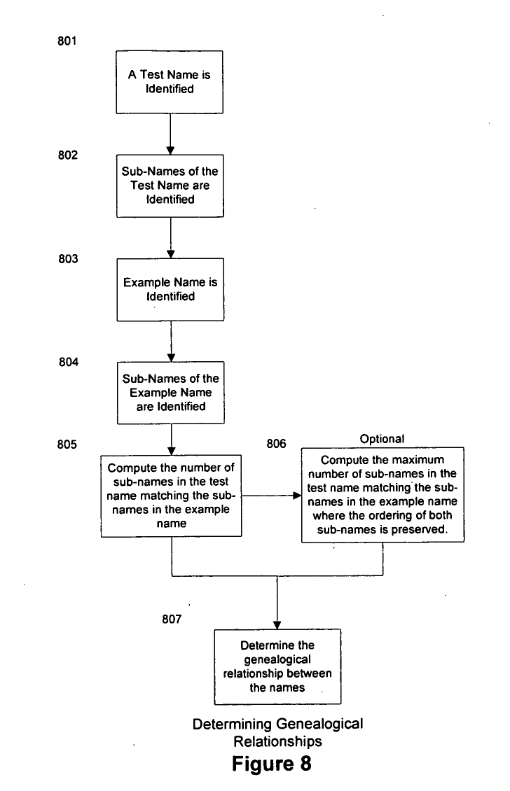

Another possible process for determining genealogical relationship is show in FIG. 8. First the sub-names of the test and example names are identified. Next, the number of sub-names common to both the test name and example name are computed. If a significant portion of these names have common sub-names, a genealogical relationship is indicated.

An optional step in this process is to identify the maximum number of sub-names the two names have in common preserving the ordering of sub-names. For instance, the names Mohamed Ahmed Ali and Kahlid Ali Ahmed have two sub-names in common, but only have one sub-name in common when the ordering of the sub-names must be preserved. When the ordering is preserved, the likelihood of a genealogical relationship is increased. However, in data collection, it is not uncommon for the sub-names to be reversed. Thus, this step is considered optional.

Finally, once a set of common sub-names has been identified, either through the process of matching sub-names or by the optional process of matching sub-names while preserving order, the genealogical relationship is estimated. If the optional process is used, the first sub-name common to both the test name and example name is examined. The location of this sub-name within the test name and example name indicates the type of genealogical relationship.

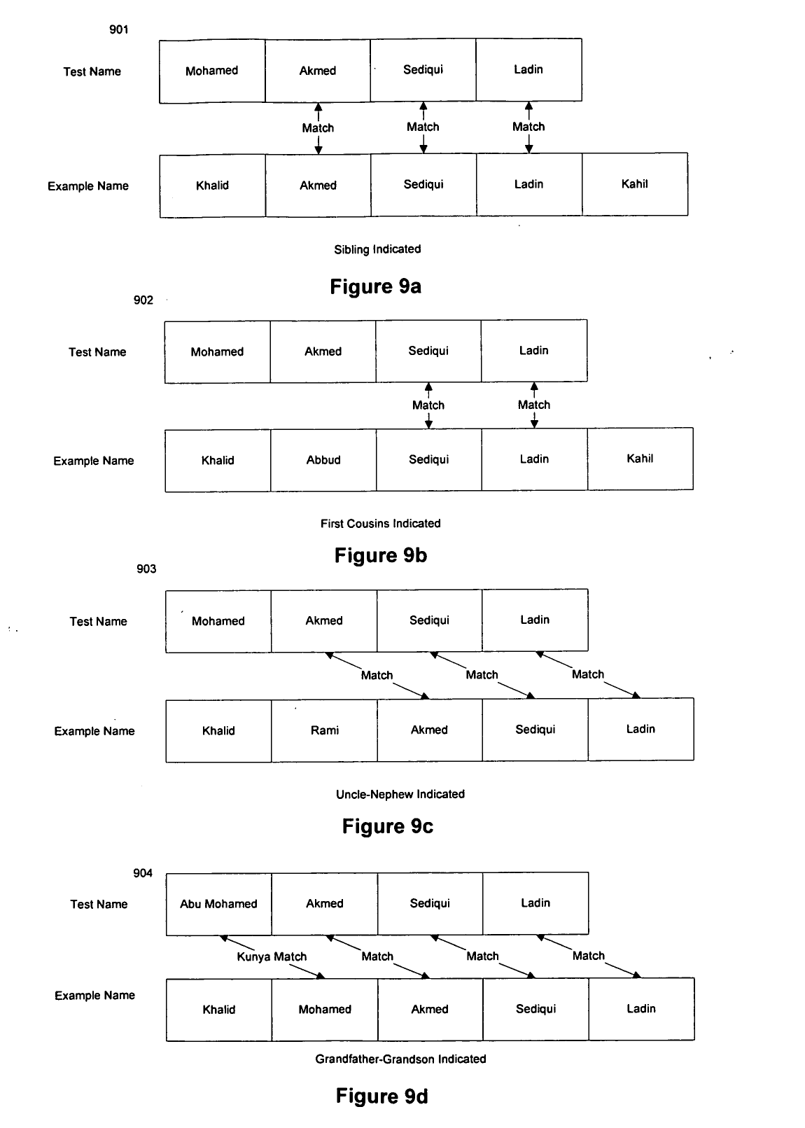

FIGS. 9a-d shows some possible relationships. In FIG. 9a, four sub-names match in order. The first matched sub-name is Ahmed. This appears as the father's name in both the test name and the example name. Thus, since the two names have a common father name, the two individuals must be siblings.

In FIG. 9b, the first matched sub-name is Sediqui. This is the grandfather's name in both the test and example name. This indicates the two individuals have the same grandfather, but different father's. In this case the two individuals are first cousins.

In FIG. 9c, the first matched name is Ahmed. This corresponds to the father's name in the test name and the grandfather's name in the example name. This indicates the test name is an uncle of the example name.

In FIG. 9d, the first matched name is Mohamed. Here, Mohamed appears as a kunya of the test name. Thus, Mohamed is the son of the test individual. This matches the father's name in the example name. This indicates that the son of the test name is father to the example name. This is a grandfather-grandson relationship.

In the case where the optional step is not used, a similar process is carried out. Each matching sub-name is checked. The location of each matched sub-name is found on the test name and example name. The relationship is computed as indicated in FIGS. 9a-d. This process is carried out for each matched sub-name and a list of possible relationships is determined.

If no names match, it is unlikely the two individuals have a genealogical relationship.

Clan Relationship

The sub-names are examined an a clan name is identified if present. The clan name can be identified by comparing the sub-name with known clan names. In addition, a clan name may be identified by external sources an associated with this name. For instance, if it is known that this individual belongs to a specific clan, that clan name may be associated with this name even though the clan name does not appear as one of the sub-names.

When comparing two names, a check is made if the names indicate they belong to the same clan.

Sub-Clan Relationship

The sub-names are examined an a sub-clan name is identified if present. The sub-clan name can be identified by comparing the sub-name with known sub-clan names. In addition, a sub-clan name may be identified by external sources an associated with this name. For instance, if it is known that this individual belongs to a specific sub-clan, that sub-clan name may be associated with this name even though the sub-clan name does not appear as one of the sub-names.

When comparing two names, a check is made if the names indicate they belong to the same sub-clan.

City Relationship

The sub-names are examined an a city name is identified if present. The city name can be identified by comparing the sub-name with known city names. In addition, a city name may be identified by external sources an associated with this name. For instance, if it is known that this individual belongs to a specific city, that city name may be associated with this name even though the city name does not appear as one of the sub-names.

When comparing two names, a check is made if the names indicate they belong to the same city.

Extent of the Relationship

The extent of the relationship between the two named individuals is indicated by examining the results of these checks. For instance, if two individuals share a common father and grandfather name, and the two have the same clan, sub-clan, and city name, it is very likely the two named individuals are siblings.

In addition, a probability of a genealogical relationship may be computed. First a study is done estimating the relative frequency of a specific name in a population. This might be worldwide, by clan, by sub-clan, by city, or by some combination of worldwide, clan, sub-clan and city. Next, the population of each group (worldwide, clan, sub-clan, and city) is estimated. From this, one can compute the probability two individuals share sub-names. This process is detained further below.

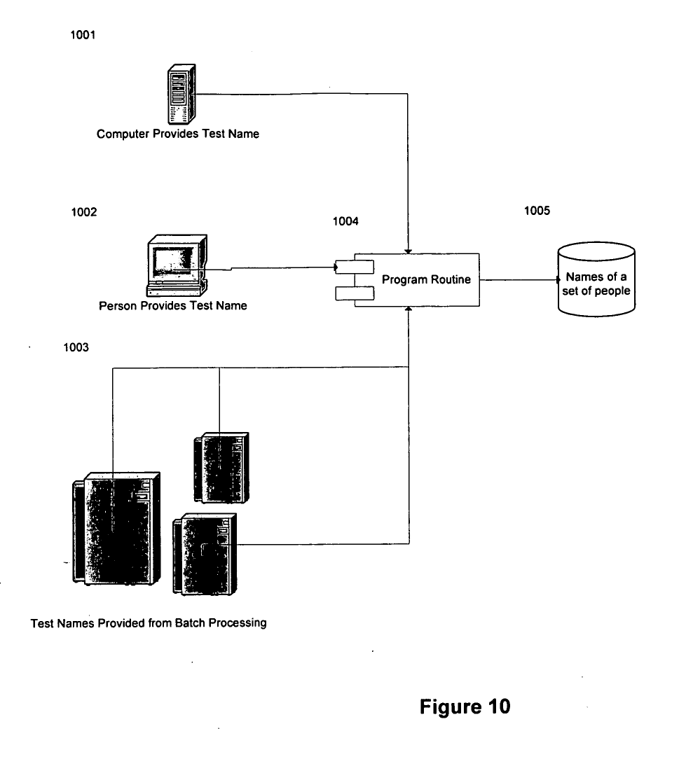

This process is readily carried out by a computer system. A potential system is shown in FIG. 10. A group of example names is provided as a dataset. This dataset may be kept as a database, text file(s), in memory, on a hard drive, DVD, CD, floppy disk, or any other computer readable media. A test name is provided to a program routine for analysis. This test name may be one of the example names, or it may be any other name of interest. The test name may be entered from a computer, a person operating a computer, a batch computing process, or any other means of entry to a program routine.

The program routine is stored on computer readable media and is able to parse a name into sub-names and compare the sub-names of the test name with the sub-names of the example names and determine possible relationships. The program may work on a single name to determine clan, sub-clan, and city names as well as discovering a kunya. If a kunya is discovered, the program routine may be used to compute a child's name solely from the parents name.

The program routine may be developed to automate the process of discovering relationships. The routine implements the methods diagrammed in FIGS. 7 and/or 8. The routine can thus determine potential relationships given the names of two individuals.

The program routine is not limited to a single process but may be a group of programs running independently or in conjunction. The routine could be run as a single process on a single computer or could be run as multiple processes on many computers. The routine could also be run in a parallel mode to enhance performance. The routine may also utilize multiple processors in a single computer or across a plurality of computers.

Process of Determining the Probability of a Genealogical Relationship

Once a potential relationship is identified through the name analysis specified above, it is useful to assign a value indicating the relative likelihood that the relationship identified is truly present. For instance, it is possible that two individuals may have similar names even though there is in fact no familial relationship between the individuals. However, the more name parts shared between two individuals, the more likely the two individuals have a familial relationship.

Thus, it is useful to assign a value based on the name comparison between two individuals. Ideally this value would be higher as the confidence that the two individuals have a familial relationship. Additionally, it is preferable that when the value assigned to a relationship between two people is compared to the value assigned between a different pair of people, a higher value for one pair indicates a relatively stronger likelihood that one pair has a familial relationship over the other pair.

Such a value is obtained by examining the probability that two names may have matching name parts merely by change. Given two names the probability of a genealogical connection may be computed. The steps to assign a probability of a genealogical relationship are specified below.

First, the relative frequency of names is found. The relative frequency is the percent of people in a population having a certain name as their given name. This may be carried out through a study of documents, by polling, by census, by sampling or any process leading to an estimation of the relative frequency of a name in some society.

The society can be any group of people. This might be worldwide, by country, by region, by clan, by sub-clan, by city, or by limiting to any group or subgroup of a population.

A name may be assigned multiple frequencies. A name may be assigned a worldwide frequency, a frequency by clan, a frequency by sub-clan, a frequency by culture, a frequency by city, or a frequency relative to any group or sub-group of interest.

In addition, various frequencies may be computed indicating temporal changes. For instance, it might be found the name Ahmed currently appears as a given name with a frequency of 0.01, but at an earlier time may have had a frequency of 0.025. This may be caused by a waxing or waning of popularity in a specific name. This temporal information might be used when examining the matching of sub-names in earlier generations.

In the preferred embodiment, a study is conducted identifying the relative frequency of given name's by worldwide population, by Arabic population, by clan, by sub-clan, and by city. These frequencies are assigned the variables f_{w}, f_{A}, f_{clan}, f_{sub-clan}, f_{city}, while the size of the populations are designated N_{w}, N_{A}, N_{clan}, N_{sub-clan}, N_{city}.

Once the frequency of names by population is known, it is possible to compare two names and assign a probability the names refer to the same person. Designate the name checked as the test name and the name to be compared as the matched name. The size of a name is the number of sub-names of the name.

This problem may arise under one of two possibilities. The first possibility is when the ordering of sub-names is knows (Ordered). The second possibility is if the ordering of sub-names of at least one of the names is not known (Unordered). Each of these possibilities is examined below.

Unordered

In this case the ordering of sub-names of at least one of the names is unknown. In this case no information may be derived from comparing the ordering of the names. Thus, the ordering of sub-names of each name may be considered as unknown.

Given a test name and a matched name, the probability these names refer to the same person may be computed. First, determine the appropriate population. Second, determine the sub-names appearing in both the test and matched names (the sub-names found on both the test and matched names is referred to the common sub-names). Third, compute the probability (ρ) of a matched name of this size with these common sub-names appearing as a member of a population of size N (N is the size of the appropriate population). Fourth, compute the expectation of the number of people in the population matching this name (<N>=ρN ). Fifth, the probability the matched name refers to the same individual as the test name is given by

$$λ = \frac{1}{1 + ρ N} . \qquad ( 1 )$$

The only item left to compute is the probability ρ. This probability will depend on the size of the test name (s) and the size of the matched name (t). This is best computed by example. If s=1, t=1 then the probability is just the frequency of the sub-name,
ρ=f₁, (2)
where f₁ is the relative frequency of the common sub-name in the population.

If s=1, t=2, the probability is determined by computing the probability the common name is not one of the names on the matched list and subtracting this result from 1:
ρ=1−(1−f₁)², (3)

This last result is easily generalized. If s=1, the probability is given by:
ρ=1−(1−f₁)¹, (4)

If s=2, t=2, the probability is determined by methods similar to the above:
ρ=1−(1−f₁)²(1−f₂)² (5)
where f₁ and f₂ are the relative frequency of the common sub-names in the population and is assumed the two sub-names are different.

Thus, the general form for the probability is:

$$ρ = 1 - {\prod }_{i = 1}^{s} {( 1 - {f}_{i} )}^{t} . \qquad ( 6 )$$

Equation (6) can be inserted into (1) to compute the probability the test and matched names refers to the same individual.

Ordered

In this case the sub-names of both the test name and matched name is known. In this

case there is information that may be derived from comparing the ordering of the names. Given a test name and a matched name, the probability these names refer to the same person may be computed. This process is substantially similar to the case above. First, determine the appropriate population. Second, determine the sub-names appearing in both the test and matched names (the sub-names found on both the test and matched names is referred to the common sub-names). Third, compute the probability (ρ) of a matched name of this size with these common sub-names appearing as a member of a population of size N (N is the size of the appropriate population). Fourth, compute the expectation of the number of people in the population matching this name (<N>=ρN). Fifth, the probability the matched name refers to the same individual as the test name is given by

$$λ = \frac{1}{1 + ρ N} . \qquad ( 7 )$$

The only item left to compute is the probability ρ. This probability will depend on the size of the test name (s) and the size of the matched name (t). Again, this is best computed by example. If s=1, t=1 then the probability is just the frequency of the sub-name,
ρ=f₁, (8)
where f₁ is the relative frequency of the common sub-name in the population.

If s=1, t=2, the probability is determined by computing the probability the common name is not one of the names on the matched list and subtracting this result from 1. This computation must also consider the names must appear in the same order as they appear in the test name.

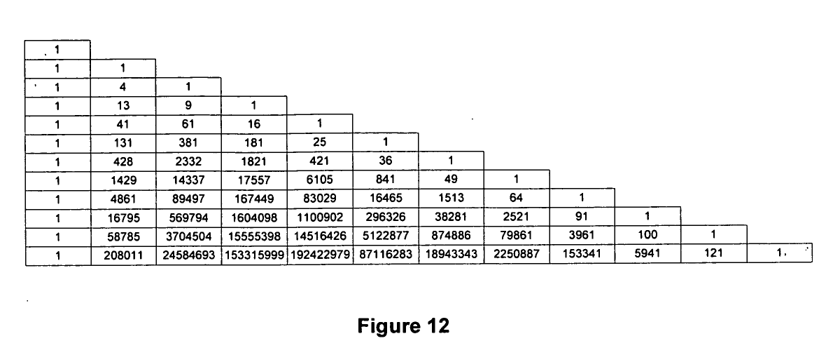

This computation is related to the largest number of ordered cycles appearing in a list. A table of these numbers appears in FIG. 12. The elements in this table are designated as χ(α, β).
ρ=1−(1−f₁)², (9)

This last result is easily generalized. If s=1, the probability is given by:

ρ=1−(1−f₁)¹, (10)

If s=2, t=2, the probability is determined by methods similar to the above:
ρ=1−(1−f₁))²(1−f₂)² (11)
where f₁ and f₂ are the relative frequency of the common sub-names in the population and is assumed the two sub-names are different.

Thus, the general form for the probability is:

$$ρ = 1 - {\prod }_{i = 1}^{s} {( 1 - {f}_{i} )}^{t} \qquad ( 12 )$$

Equation (12) can be inserted into (7) to compute the probability the test and matched names refers to the same individual.

In another embodiment, a study is conducted identifying the relative frequency of a name irrespective of whether the name is a given name or another sub-name.

In another embodiment, a study is conducted identifying the relative frequency of a name with respect to its position among sub-names.

The invention is not limited to the embodiments described above but should be construed to encompass alternative designs and implementations. For instance, the process of computing the sub-names of the example individuals may be completed while examining the test name or could be completed in advance. The computer system could be a single computer, a plurality of computers, utilize the World Wide Web, or utilize a peer-to-peer network. In addition, the steps of identifying relationships can be carried out in any order and are not limited to the order show in FIG. 7.

### DETAILED DESCRIPTION OF THE DRAWINGS

FIG. 1a shows an example of an Arabic name and specifically identifies each sub-name of the name. The Individual's name is broken into six sub-names, specifically Mohamed Akmed Ali Ladin Al-Masy Al-Tikrit (101).

FIG. 1b shows an example of an Arabic name equivalent to the name in FIG. 1a. The equivalent name Mohamed Akmed Ali is broken into sub-names (102).

FIG. 1c shows an example of an Arabic name equivalent to the name in FIG. 1a. The equivalent name Mohamed bin Laden is broken into three sub-names (103).

FIG. 1d shows an example of an Arabic name equivalent to the name in FIG. 1a. The equivalent name Mohamed Akmed Al-Masry is broken into three sub-names (104).

FIG. 1e shows an example of an Arabic name equivalent to the name in FIG. 1a. The equivalent name Mohamed Akmed Al-Tikrit is broken into three sub-names (105).

FIG. 1f shows an example of an Arabic name equivalent to the name in FIG. 1a. The equivalent name Mohamed Ali Ladin is broken into three sub-names (106).

FIG. 1g shows an example of an Arabic name equivalent to the name in FIG. 1a. The equivalent name Mohamed Ali Al-Tikrit is broken into three sub-names (107).

FIG. 2a shows an example of an Arabic name including a kunya indicating a first born son. The Individual's name is broken into seven sub-names, specifically Abu Khalid Mohamed Akmed Ali Ladin Al-Masry Al-Tikrit (201).

FIG. 2b shows an example of an Arabic name equivalent to the name in FIG. 2a. The equivalent name Abu Khalid Mohamed is broken into sub-names (202).

FIG. 2c shows an example of an Arabic name equivalent to the name in FIG. 2a. The equivalent name Abu Khalid Al-Tikrit is broken into sub-names (203).

FIG. 2d shows an example of an Arabic name equivalent to the name in FIG. 2a. The equivalent name Mohamed Abu Khalid is broken into sub-names (204).

FIG. 2e shows an example of an Arabic name equivalent to the name in FIG. 2a. The equivalent name Abu Khalid bin Mohamed is broken into sub-names (204).

FIG. 3 first shows an Arabic name and follows with several names with genealogical connections to the first name, specifically showing names of a brother. The Individual's name is broken into six sub-names, specifically Mohamed bin Akmed Ali Al-Masry Al-Tikrit (301). The name of a highly likely brother of the individual in 301 is broken into seven sub-names, specifically Abu Aban Abdul Akmed Ali Al-Masry Al-Tikrit (302). The name of a likely brother of the individual in 301 is broken into four sub-names, specifically Kahil Akmed Ali Al-Tikrit (303). The name of a likely brother of the individual in 301 is broken into four sub-names, specifically Kahil Akmed Ali Al-Masry (304). The name of a possible brother of the individual in 301 is broken into four sub-names, specifically Kahil Akmed Ali (305). The name of a possible brother of the individual in 301 is broken into four sub-names, specifically Kahil Akmed Al-Masry (306).

FIG. 4 first shows an Arabic name and follows with several names with genealogical connections to the first name, specifically showing names of a paternal first cousin.

The Individual's name is broken into six sub-names, specifically Mohamed bin Akmed Ali Al-Masry Al-Tikrit (401). The name of a likely cousin of the individual in 401 is broken into five sub-names, specifically Juhad Mehan Ali Al-Masry Al-Tikrit (402). The name of a likely cousin of the individual in 401 is broken into four sub-names, specifically Juhad Mehan Ali Al-Masry (403). The name of a likely cousin of the individual in 401 is broken into four sub-names, specifically Juhad Mehan Ali Al-Tikrit (404). The name of a possible cousin of the individual in 401 is broken into three sub-names, specifically Juhad Mehan Ali (405). The name of a possible cousin of the individual in 401 is broken into two sub-names, specifically Juhad Ali (406).

FIG. 5a provides an example of a man's name and a genealogical interpretation of the name including clan and city of origin. The Individual's name is broken into 7 parts, specificially Abu Aban Abdul Akmed, Ali Al-Masry Al-Tikrit, which means Abdul Akmed Ali, father of Aban, of the clan Masry, from the city of Tikrit (501). The Individual's name is broken into 7 parts, specificially Abu Aban Abdul bin Akmed Al-Masry Al-Tikrit which means Abdul son of Akmed, father of Aban, of the clan Masry, from the city of Tikrit (502). The Individual's name is broken into 7 parts, specifically Abu Aban Abdul ibn Akmed Al-Masry Al-Tikrit, which means Abdul son of Akmed, father of Aban, of the clan Masry, from the city of Tikrit (503). The Individual's name is broken into 7 parts, specifically Abu Aban Abdul ould Akmed Al-Masry Al-Tikrit which means Abdul son of Akmed, father of Aban, of the clan Masry, from the city of Tikrit (504). The Individual's name is broken into 7 parts, specifically Abu Aban Abdul bin Ali Al-Masry Al-Tikrit, which means Abdul son of Ali, father of Aban, of the clan Masry, from the city of Tikrit (505).

FIG. 5b provides an example of a woman's name and a genealogical interpretation of the name including clan and city of origin. The Individual's name is broken into 7 parts, specifically Um Aban Afia bint Ali Al-Masry Al-Tikrit, which means Afia daughter of Ali, mother of Aban, of the clan Masry, from the city of Tikrit (506).

FIG. 6 shows a method of identifying relationships between two people. First, one name in a set of names is identified for examination (601). Second, the name is broken into sub-names (602). Third, the clan of the name is identified (603). Fourth, the sub-clan of the name is identified (604). Fifth, the city of origin of the name is identified (605). If there are more names to examine, the procedures outlined in 601 to 605 are repeated (606). If there are no more names to examine, then processing of the set of names is complete (607). Next, a name to test against the set of names is identified (608).

Next, the test name is broken into sub-names, using the procedures outlined in 601 to 605 (609). Next, a name from the set of names to examine is chosen (610). Next, a comparison is performed between the sub-names of the test name and sub-names from the chosen name from the set of names to examine (611). Next, a check is performed to determine if there is a genealogical relationship indictated. If there is, a record of the relationship is documented (612). Next, a check is performed to determine if there is a clan relationship indictated. If there is, a record of the relationship is documented (613). Next, a check is performed to determine if there is a city relationship indictated. If there is, a record of the relationship is documented (613). Next, a determination is made as to the extent of the matching relationships (615). If there are more names to process, steps 608 to 615 are repeated (616). If there are no more names to process, the examination is complete (617).

FIG. 7 details the process of determining a genealogical relationship between two people. First, a name is checked for a Genealogical relationship (701). Second, a check to see if a Kunya is present. If the answer is affirmative, the procedures outlined in 703 and 704 are followed, otherwise, those steps are skipped (702.) The Child's name is determined (703). Any relationships found are documented (704). Next, a check is made for a Given name match. If the answer is yes, the name has the potential to be the same person, and the procedure moves to 706. If the answer is no, the procedure moves to 708 to search for relationship (705). Next, a check is made to determine if the father's name matches the test name. If the answer is yes, the name is possibly the same person, and the procedure moves to 711. If the answer is no, the procedure moves to 707. (706). The relationships found are documented. (707). A check is made to determine if the Father's name matches. If the answer is yes, the name is a potential sibling, and the procedure moves to 712. If the answer is no, the procedure moves to 709 (708.) A check is made to see if the Grandfather's name matches. If the answer is yes, the name is a potential first cousin, and the procedure moves to 715. If the answer is no, the relationships found are documented per 704, and the procedure moves to 710 (709.) Next, a check is made for matching genealogical names as far back as possible, with relationships found documented per 704 (710). A check is made to determine if the grandfather's name matches. If the answer is no, the procedure moves to 707, and the relationships found are documented. If the answer is yes, the name is a possibly the Same person, and the procedure moves to 713 (711). A check is made to determine if the Grandfather's name matches. If the answer is yes, the procedure moves to 714. If the answer is no, the relationships found are documented as per 704 (712). A check is made to determine if the Great-Grandfather's name matches. If the answer is yes, the name is likely the same person, and the procedure moves to 716. If the answer is no, relationships found are documented, per 707 (713). A check is made to determine if the name's great-grandfather matches. If the answer is yes, the name is a likely sibling, and the procedure moves to 717. If the answer is no, relationships found are documented per 707 (714). A check is made to determine if the name's great-grandfather matches. If the answer is yes, the name is a possible first cousin, and the procedure moves to 718. If the answer is no, relationships found are documented per 707 (715). Checks are made for matching genealogical names as far back as possible, the results then documented as per 707 (716). Checks are made for matching genealogical names as far back as possible, the results then documented as per 707 (717). Checks are made for matching genealogical names as far back as possible, the results then documented as per 707 (718).

FIG. 8 details the process of determining a genealogical relationship between two people. First, a test name is identified (801). Second, the sub-names of the Test Name are identified (802). Third, an example name is identified (803). Fourth, Sub names of the example name are identified (804). Fifth, the number of sub-names in the test name matching the sub-names in the example name are computed (805). Sixth, the maximum number of sub-names in the test name matching the sub-names in the example name where the ordering of both sub-names is preserved ins computed (806). Seventh, a determination is made between the names for genealogical relationship (807).

FIG. 9a shows the matching of sub-names between a Test and Example name. The Test name is Mohamed Akmed Sediqui Ladin and the Example name Khalid Akmed Sediqui Ladin Kahil match three sub-names, indicating the two individuals are siblings (901).

FIG. 9b shows the matching of sub-names between a Test and Example name. The Test name is Mohamed Akmed Sediqui Ladin and the Example name is Khalid Abbud Sediqui Ladin Kahil, match two sub-names, indicating the two individuals are first cousins (902).

FIG. 9c shows the matching of sub-names between a Test and Example name. The Test name is Abu Mohamed Akmed Sediqui Ladin and the Example name is Khalid Rami Akmed Sediqui Ladin, indicating an Uncle-Nephew relationship (903).

FIG. 9d shows the matching of sub-names between a Test and Exmpla name. The Test name is Abu Mohamed Akmed Sediqui Ladin and the Example name is Khalid Mohamed Akmed Sediqui Ladin, indicating an Grandfather-Grandson relationship (904).

FIG. 10 shows how test names are provided from Batch Processing. First, the process accepts test name input from a computer (1001). Second, the process accepts test name input from a person (1002). Third, the process accepts test names provided from batch processing (1003). Next, the program routine records the provided names (1004) Finally The names of a set of people are added into a database (1005).

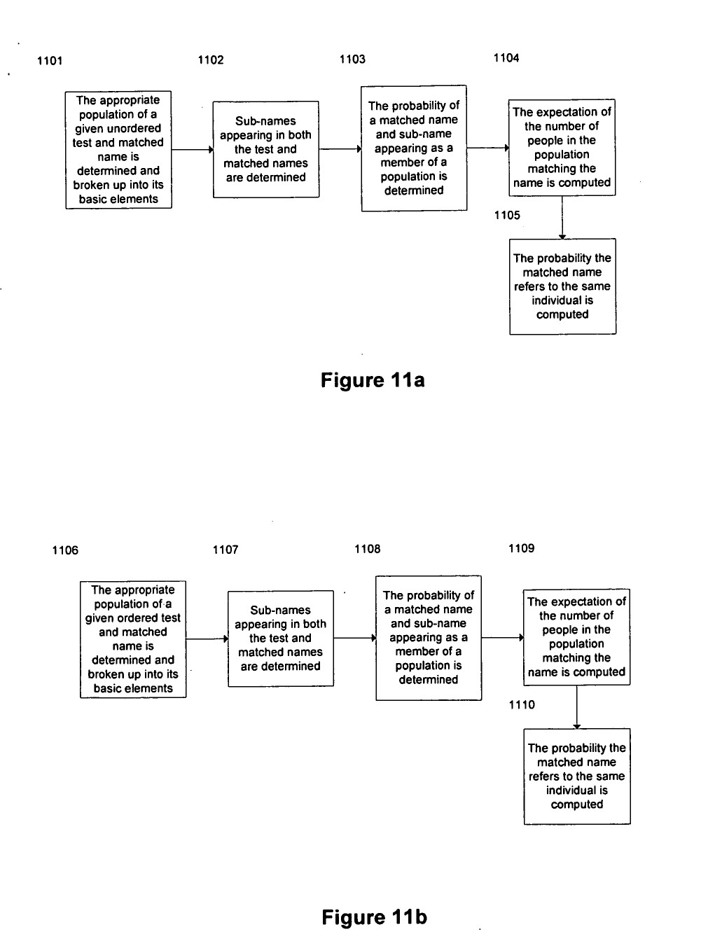

FIG. 11a shows the process for calculation or computing the score using an unordered test. First the appropriate population of a given unordered test and matched name is determined and broken up into name parts (1101). Next, the sub-names appearing both the test and matched names are determined (1102). Third, the probability of a matched name and sub-name appearing as a member of a population is determined (1103). Fourth, the expectation of the number of the number of people in the population matching the name is computed (1104). Finally, the probability the matched name refers to the same individual is computed (1105.)

FIG. 11b shows the process for calculation or computing the score using an ordered test. First the appropriate population of a given unordered test and matched name is determined and broken up into name parts (1101). Next, the sub-names appearing both the test and matched names are determined (1102). Third, the probability of a matched name and sub-name appearing as a member of a population is determined (1103). Fourth, the expectation of the number of the number of people in the population matching the name is computed (1104.) Finally, the probability the matched name refers to the same individual is computed (1105.)

FIG. 12 shows a table of the numbers of ordered cycles appearing in a list.

We claim:

1. A method of identifying relationships between a plurality of people, the method comprising the steps of:
examining the names of a set of people by identifying the name of each person in the set of people; and
for each person in the set of people, identifying the subnames of the person; and
examining the name of a test individual by identifying each of the test individuals subnames; and
comparing the subnames of the test individual with the subnames of each person in the set of people to determine the relationships between the test individual and each person of the set of individuals; and
a means for assigning a relative weight to the likelihood that the identified relationship is present.

2. The method of claim 1, wherein the relationship determined is a genealogical relationship, and the means for assigning a relative weight to the identified relationship is based in part on
the probability the names match using an unordered analysis; and/or
the probability the names match using an ordered analysis.

3. The method of claim 2, wherein the genealogical relationship is capable of detecting a relationship between paternal first cousins or maternal first cousins.

4. The method of claim 2, wherein the genealogical relationship is capable of detecting a parent-child relationship when the test individual is the parent and the child is not among the set of people.

5. The method of claim 4, wherein at least one person in the set of people has at least three subnames and the test individual has at least two subnames.

6. The method of claim 4, wherein the test individual's subnames include the test individuals father's first given name.

7. The method of claim 3, wherein the test individual's subnames include the test individuals father's first given name, the test individual's grandfather's first given name, and where the test individuals father's first given name and the test individuals grandfather's first given name are different.

8. The method of claim 3, wherein the test individual's subnames include the test individuals mother's first given name.

9. The method of claim 3, wherein the test individual's subnames include the test individuals mother's first given name, the test individual's grandmother's first given name, and where the test individuals mother's first given name and the test individuals grandmother's first given name are different.

10. A software system for identifying relationships between a plurality of people, the software system comprising:
a dataset, containing in part names of a set of people; and
a name of a test individual including at least one subname; and
a program routine contained on computer readable media comprising:
a means for parsing the test individuals name into subnames,
a means for comparing the test individuals subnames with the subnames in the dataset, and
a means for determining a genealogical relationship between the test individual and each person in the dataset; and
a means for assigning a relative weight to the likelihood that the identified relationship is present.

11. The method of claim 10 wherein the means for assigning a relative weight to the identified relationship is based in part on
the probability the names match using an unordered analysis; and/or
the probability the names match using an ordered analysis.

12. The method of claim 11, wherein at least one person in the set of people has at least two subnames.

13. The method of claim 11, wherein at least one person in the set of people has at least three subnames.

14. The method of claim 11, wherein at least one person in the set of people has at least four subnames.

15. The method of claim 11, wherein the means for determining a genealogical relationship includes a computation based in part on the relative frequency a name appears in a clan or geographical region.

16. The method of claim 11, wherein the test individual has at least three subnames.

17. The method of claim 11, wherein the test individual has at least four subnames.

18. The method of claim 11, wherein the relationship determined is a genealogical relationship.

19. The software system of claim 11, wherein the name of the test individual is also a member of the set of people in the dataset.

20. The software system of claim 18, wherein the means for determining a genealogical relationship includes a means for detecting a genealogical relationship between paternal first cousins or maternal first cousins

21. The software system of claim 19, wherein the dataset is a database contained on computer readable media.

22. The software system of claim 19, wherein the test individual has at least four subnames and at least one of the set of people has at least four subnames.

23. The software system of claim 11, wherein the programming means further comprises a means for determining a test individuals place of origin.

24. The software system of claim 18, wherein the means for determining a genealogical relationship includes a means for determining the name of a child given as input only the name of a parent and where the name of the child is not a member of the dataset.

25. The software system of claim 18, wherein the means for determining a genealogical relationship includes a means for determining if the test name is the same as a name in the set of people when the test name is not identical to the name in the set of people.

26. The software system of claim 25, wherein the means for determining a genealogical relationship includes a means for detecting transliteration variants using a topological token.
